(19) United States
(12) Patent Application Publication
(10) Pub. No.: US 2009/0131840 A1
(43) Pub. Date: May 21, 2009

(54) Massage Device Used For Throughout the Shoulder and Mattress With Thereof

(76) Inventor: Dong In Lee, Seoul (KR)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 10/544,563

(22) PCT Filed: Feb. 6, 2004
(86) PCT No.: PCT/KR2004/000232

§ 371 Date: Dec. 13, 2007

(30) Foreign Application Priority Data
Feb. 7, 2003 (KR) 10-2003-0007945
Oct. 28, 2003 (KR) 10-2003-0075692
Oct. 28, 2003 (KR) 10-2003-0075693

(51) Int. Cl. A61H 1/00; A61H 1/02

(52) U.S. Cl. 601/15

(57) ABSTRACT

Disclosed is a very low frequency wave heating massager for shoulders including: a cover part of a “C” shape that is bent to conform to the structure of the human body at the portion against which his or her neck and shoulder abut to thereby surround the whole of the shoulder; a plurality of heat generators to generate heat; a shield material adapted to be connected between the adjacent heat generators for shielding the electromagnetic waves therefrom; a vibrating massage part in which one of a vibrating motor and a solenoid are mounted; a very low frequency wave generator; and a controller connected to the cover part.

### TECHNICAL FIELD

The present invention relates to a very low frequency wave heating massager for a shoulder and a heating massage mattress with the same mounted thereon, and more particularly, to a very low frequency wave heating massager for a shoulder that includes a cover part that is of a “C” shape that is bent to conform to the structure of the human body at the portion against which his or her neck and shoulder abut to thereby surround the whole of the shoulder, a plurality of heat generators that are heated by heat generating means to which power is supplied, a shield material that is adapted to shield the electromagnetic waves between the adjacent heat generators, a vibrating massage part in which one of a vibrating motor and a solenoid are mounted, a very low frequency wave generator, and a controller that is connected to the cover part in such a manner as to control a low frequency generator that is disposed inside the cover part and has a plurality of low frequency pads attached thereon through a signal outputted therefrom. The controller drives the vibrating massage part and the very low frequency wave generator that are electrically connected inside a wing part that is formed bent to conform to the structure of the shoulder in such a manner as to abut against the trapezius at the back portions of the shoulder and the neck at a right angle, whereby the cover part and the wing part are fixedly coupled to each other. Also, the present invention relates to a heating massage mattress with the very low frequency wave heating massager for a shoulder mounted thereon that includes an outer surface layer; a buffering material, a plurality of heating wires, a plurality of solenoids and a massage rod on the top end of each of the solenoids disposed at predetermined spaces inside the outer surface layer; and a controller for controlling the whole operation of the mattress.

### BACKGROUND ART

Generally, people who work for a substantially long period of time at offices, especially people who work all day with computers as the number of people using the computers increases, usually feel a bad pain in their shoulders. At that time, however, if their shoulder muscles are not properly relaxed, they get chronic pain. This of course may make their working efficiency. substantially lowered and also may cause a variety of physical diseases due to stress.

Conventional massagers for shoulders do their massaging operation with just physical stimulus, and in case of conventional heating massage mattresses, when a user lies in the mattress, he or she feels that his back is heated but does not feel any heat on his or her shoulders since the shoulders are generally separated from the mattress.

To solve these problems, thus, there have been disclosed various kinds of pillows for giving heat to the shoulder and neck and for massaging them. These examples are disclosed in Korean Utility Model Registration Nos. 2001-0018966, 2001-0031515, and 2001-0018965, wherein since the pillow is formed integrally with the shoulder area thereof, heat is transmitted only to the bottom area against which the neck and shoulders abut, and thus, the heat is not covered to the top portions of the shoulders and to the region from each shoulder to the breast, which fails to make the inside muscles fully relaxed.

In the case of a vibrating massager that applies physical stimulus to a user, the massage should be desirably conducted in a state where the strength of the user's shoulders is relaxed. In the conventional vibrating massagers, however, he or she must hold the massager with his or her hand during massaging, thereby making it difficult to fully relax the shoulder muscles.

Moreover, in case of a very low frequency wave heating massager for shoulders, it is easy to apply the massage to his or her shoulders in a state where he or she lies in his or her bed, but it is difficult to apply the massage in a state where he or she sits on a chair or a floor and even while he or she is moving his or her upper part.

On the other hand, most of examples of the physical treatment appliances of making shoulder muscles relax are massagers that have only a function of applying heating and/or vibration, and there have not been disclosed any massager for shoulders that have all functions of applying heating, vibration, low frequencies, and negative ions, while using very low frequency wave waves and low frequencies. Moreover, there has been disclosed no heating massage mattress that has functions of applying heating and massaging to the whole of body, while making the shoulder muscles completely relaxed.

### SUMMARY

Accordingly, the present invention has been made to solve the above-described problems, and it is an object of the present invention to provide a very low frequency wave heating massager for shoulders that can heat the whole of the shoulders through the heat generated from a plurality of heat generators on a cover part surrounding the whole of the shoulders in a “C” shape, thereby allowing the shoulder muscles to be fully relaxed and also allowing fatigue substances like lactic acid to be discharged out of the skin through sweat. The present invention can vibrate the shoulder muscles, relaxed by the heat, by means of a vibrating motor inside a wing part attached to a cover part, thereby allowing the shoulder muscles to be more relaxed before, and that since the cover part is formed of a heat retaining material that is in close contact with the shoulder, cannot move or slid at a state where a user works, while sitting on a chair, thereby providing various physical treatment effects over the whole of the shoulders.

It is another object of the present invention to provide a heating massage mattress with a very low frequency wave heating massager for shoulders detachably mounted on the upper part thereof, that includes an outer surface layer and a buffering material, a plurality of heating wires, a plurality of solenoids and a massage rod on the top end of the solenoids that are all disposed at predetermined spaces inside the outer surface layer.

According to the above objects of the present invention, there is provided a very low frequency wave heating massager for shoulders which includes a cover part that is of a “C” shape that is bent to conform to the structure of the human body at the portion against which his or her neck and shoulder abut to thereby surround the whole of the shoulder. A plurality of heat generators are heated by heat generating means to which power is supplied. A shield material is adapted to be connected between the adjacent heat generators for shielding the electromagnetic waves therefrom. A vibrating massage part is included. in which one of a vibrating motor and a solenoid are mounted. Also, a very low frequency wave generator, and a controller (not shown) that is connected to the cover part are included.

### BRIEF DESCRIPTION OF THE DRAWINGS

Further objects and advantages of the invention can be more fully understood from the following detailed description taken in conjunction with the accompanying drawings, in which:

FIG. 1 is a view showing a very low frequency wave heating massager for shoulders according to an embodiment of the present invention;

FIG. 2 is a sectional view of FIG. 1;

FIG. 3 is a view showing an example where the very low frequency wave heat shoulder of the present invention is put on a user's shoulders;

FIG. 4 is a view showing another example where the cover part of the present invention is connected to a pillow;

FIG. 5 is a sectional view of FIG. 4;

FIG. 6 is a perspective view of a very low frequency wave heating massager for shoulders with a wing part attached thereon according to another embodiment of the present invention;

FIG. 7 is a perspective view showing another example of the very low frequency wave heating massager for shoulder with a wing part attached thereon;

FIG. 8 is a sectional view of the parts inside the cover part and the wing part;

FIG. 9 is a sectional view of the parts inside the cover part and the wing part to which a vibrating motor is additionally mounted;

FIG. 10 is a sectional view showing an example where the cover part and the wing part are fixed to each other;

FIG. 11 is a sectional view showing another example where the cover part and the wing part are fixed to each other;

FIG. 12 is an enlarged sectional view of the vibrating massage part;

FIG. 13 is a sectional view showing the connection of electric power between the cover part and the wing part;

FIG. 14 is a perspective view showing a heating massage mattress to which the very low frequency wave heating massager for shoulder is mounted; and

FIG. 15 is a sectional view of FIG. 14.

### DETAILED DESCRIPTION OF PREFERRED EMBODIMENTS

Now, an explanation of the preferred embodiments of the present invention will be given in detail with reference to the attached drawings. A very low frequency wave heating massager for shoulders 100 according to the present invention includes a cover part 50 that is of a “C” shape that is bent to conform to the structure of the human body at the portion against which his or her neck and shoulder abut to thereby surround the whole of the shoulder, a plurality of heat generators 10 that are heated by heat generating means to which power is supplied, a shield material 11 that is adapted to be connected between the adjacent heat generators 10 for shielding the electromagnetic waves therefrom, a vibrating massage part 20 in which one of a vibrating motor 21 and a solenoid 22 are mounted, a very low frequency wave generator 30, and a controller (not shown) that is connected to the cover part 50.

According to the present invention, especially, the controller is connected to the cover part 50 in such a manner to control a low frequency generator 21 that is disposed inside the cover part 50 and has a plurality of low frequency pads 41 attached thereon through a signal outputted therefrom, and otherwise, the controller drives the vibrating massage part 20 and the very low frequency wave generator 30 that are electrically connected to each other inside a wing part 54 that is formed bent to conform to the structure of the shoulder in such a manner as to abut against the trapezius at the back portions of the shoulder and the neck at a right angle, whereby the cover part 50 and the wing part 54 are fixedly coupled to each other.

According to the present invention, a heating massage mattress 70 includes: an outer surface layer 71; a buffering material 75; a plurality of heating wires 72; a plurality of solenoids 74 disposed at predetermined spaces inside the outer surface layer 71, the buffering material 75 and the plurality of heating wires 72 being disposed inside the outer surface layer 71; a plurality of massage rods 73 each mounted on the top end of each of the solenoids; and a controller for controlling the whole operation of the mattress, wherein the heating massage mattress has the very low frequency wave heating massager for shoulder 100 detachably mounted by means of Velcro strips 57 at the upper portion thereof.

An explanation of the technical features of each part of the present invention will be given blow.

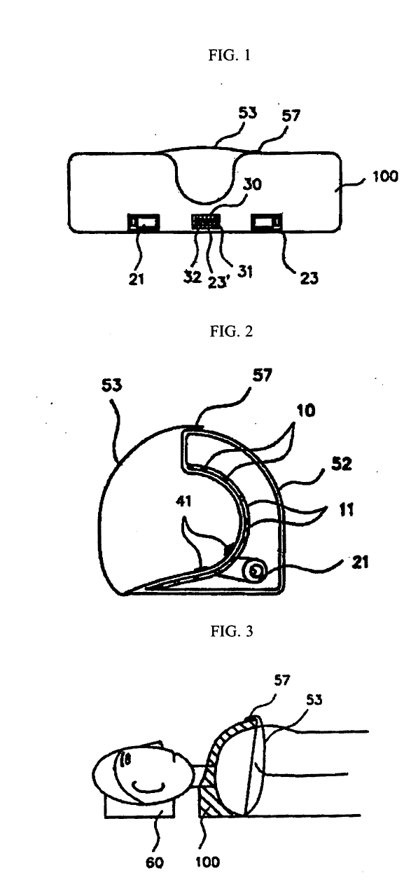

The controller is adapted to control the temperature of the heat generators 10 or to control the operation periods of the vibrating motor 21 and the very low frequency wave waves, and since the technical concepts of it are well known, an explanation of it will be avoided herein for the brevity of description. 15 As shown in FIGS. 1 to 3, according to the very low frequency wave heating massager for shoulders, the low frequency generator 21 on which the low frequency pads 41 are attached is disposed inside the cover part 50 and is operated by the output signal from the controller. The cover part 50 is of a C shape in such a way as to become tightly contacted with the neck and shoulder, while covering the whole of shoulder. The cover part 50 has the heat generating means 20 that generates heat built therein and a temperature sensor disposed around the heat generating means, for the purpose of sensing the temperature in the cover part 50 and checking whether the circuit is shorted.

Further, the cover part 50 has the shield material 11 connected between the adjacent heat generators 10, for shielding the electromagnetic waves generated therefrom. The cover part 50 is 25 further provided with hollow portions 23 and 23′ in which the vibrating motor 21 and the very low frequency wave generator 30 are disposed, for massaging and relaxing the trapezius at the back portions of the shoulder and the neck. Thereby, it is possible to conduct strong vibration and massage and if the massager is used while a user lies in the bed, the cover part 50 and a pillow 60 are placed in such a manner as to be separated from each other, whereby the vibration and heating are not transmitted to his or her head. Thus, the vibration and heating are applied to the neck and shoulder at a substantially strong strength.

In the case where he or she lays his or her head on the pillow 60, the cover part 50 has a substantially vertical groove formed on the outer peripheral surface for reducing the area abutting the pillow 60 such that the amount of the heat transmittable to the pillow 60 can be remarkably reduced.

Thereby, the neck and shoulder where muscles are often tense get hot and the pillow on which the head is placed gets cool.

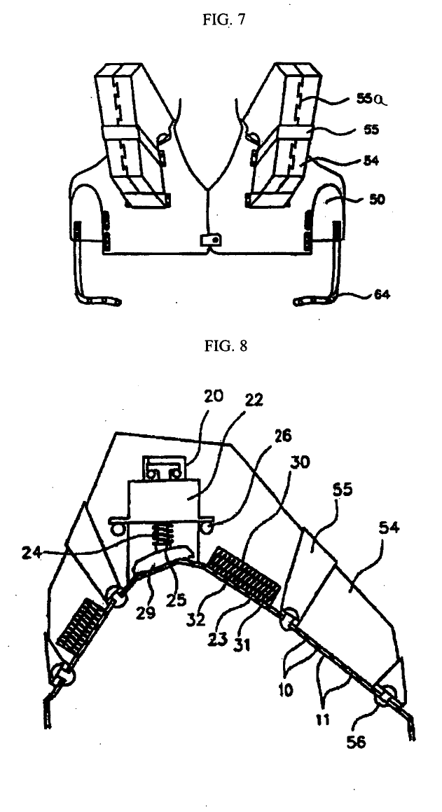

If the temperature of the pillow 60 is forced low, as shown in FIGS. 5 and 6, the pillow 60 may be provided with suction holes 61 that are placed at the rear side thereof and a blower 62 that is placed near the suction holes 61 in the interior thereof.

Furthermore, if a discharging hole is provided at the shoulder side and at the upper side of the pillow 60, respectively, the head becomes cooler and the neck and shoulder become hotter.

In case of the vibrating motor 21 for massaging the shoulder, a vibrating motor casing has a shape like a shoulder line at a portion being touched with the shoulder and has the vibrating motor 21 fixed at the back thereof. After that, it is inserted into the hollow portion 23 of the cover 50 and if the user lies in the bed, strong massaging effect can be achieved by the load of the vibrating motor.

The very low frequency wave generator 30 includes a very low frequency wave generating means that is composed of a very low frequency wave core 31 and a very low frequency wave coil 32 wound around the very low frequency wave core 31 and is inserted into the hollow portion 23′ of the cover part 50, thereby conducting the very low frequency wave generating massage.

The low frequency generator includes a cloth surrounding the cover part 50 or additionally includes the low frequency pads 41. In this case, if a low frequency signal is sent to the low frequency pads 41 by the control of the controller, the muscles on the low frequency pads 41 are relaxed to thereby obtain another physical massaging effect.

Also, the cover part 50 is formed of foamed high molecular compounds such as foamed natural rubber or foamed urethane synthetic rubber. In a manner of manufacturing the body of the cover part 50, negative ion emitting materials in which ore powder such as natural jade, loess, or tourmaline is contained are filled there into such that the negative ions are generated from the body of the cover part 50, while the heat is being transmitted over the shoulder. As well known, the negative ion emitting materials serve to neutralize the acidified blood to alkaline blood to thereby make the blood clean. Further, they allow the activation of the cells and the reduction of pain.

In case of the cover part 50 itself being made of a piece of cloth, on the other hand, it is provided with plastic or a shape memory alloy material 51 that is inserted there into such that the body of the cover part 50 can be maintained in shape.

To protect the heat generators 10, the vibrating motor 21 and the very low frequency wave generator 30 in the cover part 50 and to allow sweat to be well absorbed, the cover part 50 has a cover 52 that is made of a piece of cloth or hair spread on the outer peripheral surface thereof.

On the other hand, the heat generating means of each of the heat generators 10 is employed with not only a low temperature heating element like a heating wire or a heating plate but also a high temperature heating element like a far infrared lamp, a halogen lamp or a ceramic heater. In case of using such the high temperature heating elements, the cover part 50 has a hollow portion from which a space is formed so that the heating elements are not directly touched with the skin or has a glass or net with which the skin is protected from being burnt.

The very low frequency wave heating massager for shoulders of the present invention is used in a manner that a user can wear the cover part 50 inside an outer garment or in a manner where he or she can wear the cover part 50 as the outer garment like a mantle such that the massager of the present invention can be used during daily time as well as sleeping. Further, the cover part may be provided with a face heating element that is adapted to generate heat on the neck and shoulder, which is operated by batteries or an adaptor jack.

To prevent the cover part 50 from being slid or moved on the shoulder, there are provided a fixing band 53 or a Velcro strip 57 that is detachably mounted under the arm or at the front of the shoulder.

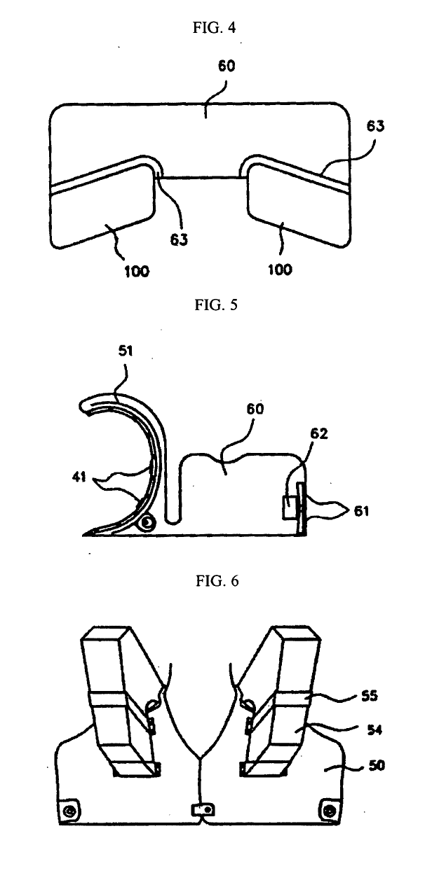

In case of connecting the cover part 50 with the pillow 60 as an integral body with each other, as shown in FIGS. 4 and 5, to not directly transmit the heat generated in the cover part 50 to the pillow 60, there is provided a space 63 that is formed between the cover part 50 and the pillow 60 in such a manner as to connect the cover part 50 with the pillow 60 on their bottom portions. The pillow 60 has the blower 62 that is adapted to blow the cool air sucked from the outside to the cover part 50 and the shoulder and neck or above the pillow 60 such that the head stays cool and the shoulder and neck stay hot.

FIG. 6 is a perspective view of a very low frequency, wave heating massager for shoulder with a wing part attached thereon according to another embodiment of the present invention. In this embodiment, the very low frequency wave heating massager for shoulder includes a cover part 50 that is made of a material that is in close contact with the shoulder with ease and has a heat retaining property and a wing-part 54 that is made of a flexible foamed material and is formed on the cover part 50 in a manner of being bent along the shoulder line, while abutting against the trapezius at the back portions of the shoulder and the neck at a right angle thereto.

As shown in FIG. 7, the wing part 54 is provided with a concave groove coupling structure 55a for preventing the generation of noises and for providing easy assembling, and a fixing band 64 on which buttons are placed and a Velcro strip are detachably mounted under the arm and at the front of the shoulder.

An explanation of the parts inside the cover part 50 and the wing part 54 is given with reference to FIG. 8. Inside the cover part 50 are disposed the heat generators 10 that are heated by means of the heat generating means to which power is applied and the shield material 11 that serves to shield the electromagnetic waves between the adjacent heat generators, thereby providing the heating function to the massager of the present invention.

Inside the cover part 50, also, there is the vibrating massage part 20 that has a massaging function, including a plunger 24, a solenoid 22 with a bushing 27 (FIG. 12) mounted therein, a massage plate 29 disposed on the top end of the solenoid 22 and the plunger 24 for massaging the whole of shoulder including the trapezius, and a returning spring 25 fitted around the plunger for applying an elastic force to the plunger 24 such that the plunger 24 is returned to its original position.

Specifically, the massage plate 29 is formed in such a manner as to be inclined to conform to the shoulder line somewhat curved to just strike the trapezius of the shoulder such that the shoulder massaging effect can be promoted. FIG. 12 is an enlarged sectional view of the vibrating massage part, and as shown, the plunger 24 and the bushing 27 have a square shape not to rotate the inclined massage plate 29 uselessly. The vibrating massage part 20 that is operated by the solenoid 22 is simply inserted and mounted into the wing part 54 by means of a pair of fixing pins 26.

At the inside of the wing part 54 is provided the hollow portion 23 into which the very low frequency wave generator 30 being comprised of the very low frequency wave core 31 and the very low frequency wave coil 32 is placed, thereby providing the very low frequency wave massaging function to the massager of the present invention. The vibrating massage part 20 and the very low frequency wave generator 30 are electrically connected to each other and driven by the control of the controller (not shown).

As shown in FIG. 9, the vibrating motor 21 is further provided in the structure of FIG. 8, thereby providing a vibrating effect by the use of the vibrating motor 21 so that the massaging effect can be more improved.

On the other hand, as the very low frequency wave heating massager for shoulder should be used while a user is sitting on a chair, the cover part 50 is desirably formed of a heat retaining material in a manner of being closely contacted with the shoulder line such that it is moved slightly along the movement of the shoulder, and so as to maintain the shoulder line in the cover part 50 without any change in shape, a pad or a shape memory alloy material may be mounted in the cover part 50.

The wing part 54 is made of plastic and preferably of a foamed polyurethane material, which serves to absorb the noises due to the operation of the solenoid inserted into the cover part and to move gently along the movement of the body.

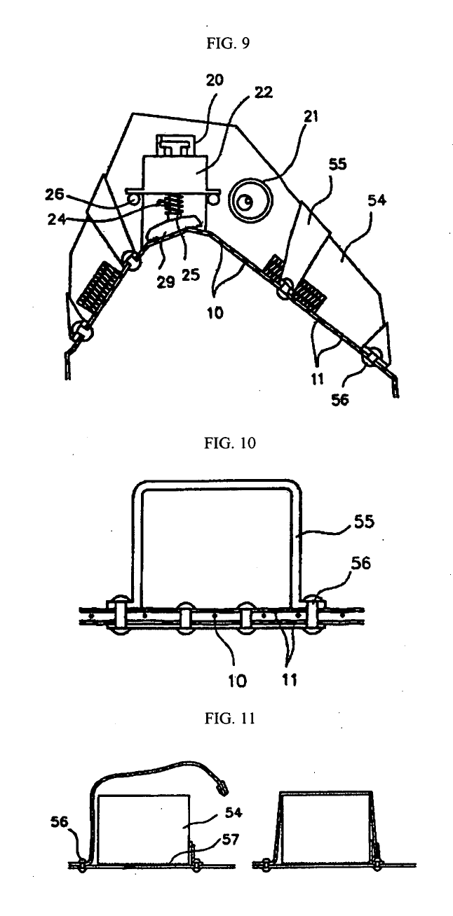

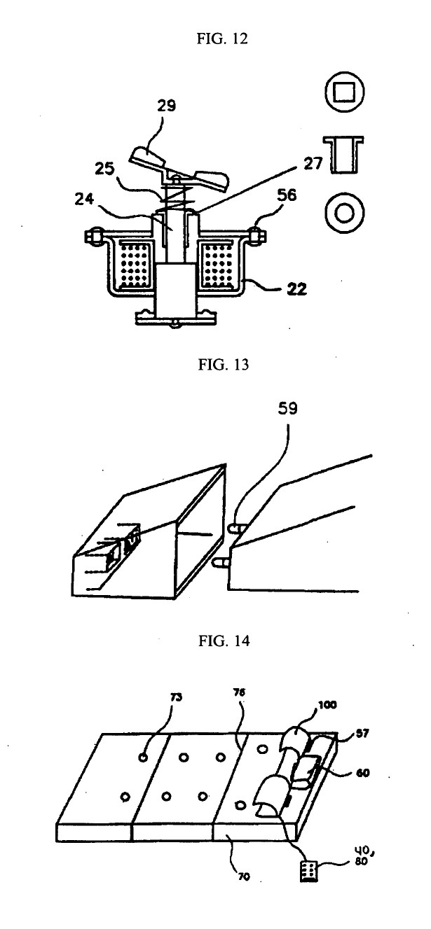

As shown in FIG. 10, the cover part 50 and the wing part 54 are coupled in such a manner that a cap 55 is mounted (see also FIG. 7) to cover the wing part 54 and after the cover part 50 is provided with a pad on the lower portion thereof, it is fixedly connected to the wing part 54 by means of rivets 56. In another manner of coupling the cover part 50 and the wing part 54, as shown in FIG. 11, a Velcro strip 57 is attached on the portion where the cover part 50 abuts the shoulder or a fixing band 58 is attached to couple the cover part 50 with the wing part 54. The cover part 50 and the wing part 54 are connected and driven by electric cords 59, as shown in FIG. 13.

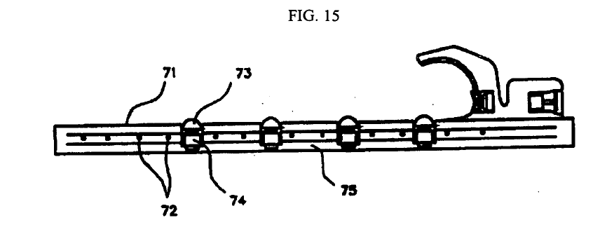

An explanation of a heating massage mattress to which the very low frequency wave heating massager for shoulders is attached according to the present invention will be given with reference to FIGS. 14 and 15. The heating massage mattress 70 includes: an outer surface layer 71 from which far infrared emitting elements are protrudedly formed if necessary; a buffering material 75 and a plurality of heating wires 72 disposed at a predetermined space inside the outer surface layer 71, each of the plurality of heating wires 72 being connected with a shield material such that the electromagnetic waves emitted from each heating wire are shielded; a plurality of solenoids 74 disposed at predetermined points inside the outer surface layer 71; a generally hemispherical massaging rod 73 disposed on the top end of the plunger of each of the solenoids 74, for conducting a real massaging operation; and a heating massage mattress controller (80) electrically connected to the heating massage mattress 70 for supplying power to the heating wires 72 and the solenoids and at the same time for adjusting a temperature of the mattress and a degree of vibration of the solenoids. Technical concepts of the controller are well known,. and therefore, an explanation of it will be avoided for the brevity of description.

FIG. 14 is a perspective view showing the heating massage mattress to which the very low frequency wave heating massager for shoulder is attached. The main body 100 of the massager for shoulder that is connected as a unitary body with the pillow 60 is mounted on the upper portion of the mattress 70 by means of the Velcro strips 57, and the heating massage mattress 70 and the very low frequency wave heating massager for shoulders 100 are driven in set modes by the heating massage mattress controller and the controller of the massager for shoulder (shown as controlled 80).

On the other hand, the heating massage mattress 70 is divided into several subsections that are folded by a typical folding means 76 such that if the upper part of the mattress is folded, a user can use it while sitting thereon. When it is folded, in addition, it is easy to move the mattress or keep it at a predetermined place.

As set forth in the foregoing, there is provided a very low frequency wave heating massager for shoulder that can heat the whole of the shoulders through the generated heat from a plurality of heat generators on a cover part surrounding the whole of the shoulders in a C shape, thereby allowing the shoulder muscles to be fully relaxed and also allowing fatigue substances like lactic acid to be discharged out of the skin through sweat, that can vibrate the shoulder muscles relaxed by the heat by means of a vibrating motor inside a wing part attached to the cover part, thereby allowing the shoulder muscles to be more relaxed before, and that since the cover part is a heat retaining material that is in close contact with the shoulder, cannot move or slid at a state where a user works, while sitting on a chair, thereby expecting various physical treatment effects over the whole of the shoulders. The heating massage mattress according to the present invention that has the very low frequency wave heating massager for shoulder detachably mounted on the upper portion thereof is used while a user lies on the mattress such that his or her shoulders and body can be heated and massaged, which desirably causes the circulation of blood to be promoted.

While the present invention has been described with reference to a few specific embodiments, the description is illustrative of the invention and is not to be construed as limiting the invention. Various modifications may occur to those skilled in the art without departing from the true spirit and scope of the invention as defined by the appended claims.

1. A very low frequency wave heating massager for shoulders comprising: a cover part of a “C” shape that is bent to confirm to the structure of the human body at the portion against which his or her neck and shoulder abut to thereby surround the whole of the shoulder; a plurality of heat generators heated by heat generating means to which power is supplied; a shield material adapted to be connected between the adjacent heat generators for shielding the electromagnetic waves therefrom; a vibrating massage part (20) in which one of a vibrating motor and a solenoid are mounted; a very low frequency wave generator; and a controller connected to the cover part.

2. A very low frequency wave heating massager for shoulders of claim 1, further comprising a low frequency generator that is disposed inside the cover part, the low frequency generating having a plurality of low frequency pads attached thereon and being operated by a control signal of the controller.

3. A very low frequency wave heating massager for shoulders of claim 2, wherein the vibrating massage part has the vibrating motor disposed into a hollow portion in the cover-part and conducts a vibration massaging operation as the vibrating motor is driven.

4. A very low frequency wave heating massager for shoulders of claim 2, wherein the cover part additionally includes a pillow disposed at the outside thereof in such a manner that the bottom portion of the cover part is connected with the bottom portion of the pillow, while a space is formed between the cover part and the pillow for insulating heat between the cover part and the pillow, and the pillow is provided with a blower that is disposed in the interior thereof, for making a temperature of the pillow lower.

5. A very low frequency wave heating massager for shoulders of claim 1, wherein the cover part is further provided with a wing part that is formed thereon, the wing part being bent to conform to the structure of the shoulder in such a manner as to abut against the trapezius at back portions of the shoulder and neck at a right angle, and the vibrating massage part that is operated by one of the vibrating motor and the solenoid are electrically connected to the very low frequency wave generator inside the wing part and is driven by the control of the controller, whereby the cover part and the wing part are fixedly coupled to each other.

6. A very low frequency wave heating massager for shoulders of claim 5, wherein the vibrating massage part comprises a plunger, a solenoid with a bushing mounted therein, a massage plate disposed on the top end of the plunger and having a shape inclined to conform to the bent region of the shoulder, and a returning spring fitted around the plunger for applying an elastic force to the plunger such that the plunger is returned to its original position, and wherein the vibrating massage part is inserted and mounted into the wing part by means of a pair of fixing pins.

7. A very low frequency wave heating massager for shoulders of claim 5, wherein the cover part and the wing part are coupled to each other in such a manner that a cap is mounted to cover the wing part and after the cover part is provided with a pad on the lower portion thereof, the cover part is fixedly connected to the wing part using a rivet to secure the cap, in such a manner as to attach where the cover part abuts the shoulder.

8. A very low frequency wave heating massager for shoulders of claim 2, wherein the cover part has a pad or a shape memory alloy material mounted therein, for maintaining the shape of the cover part like the shoulder line of the body, without any change in shape, and a fixing band attached to the outside thereof for preventing the cover part from being slid or moved.

9. A heating massage mattress with the very low frequency wave heating massager for shoulders of claim 1 detachably mounted thereon.

10. A heating massage mattress with the very low frequency wave heating massager for shoulders of claim 9, wherein the heating massage mattress comprises an outer surface layer; a buffering material, a plurality of heating wires, a plurality of solenoids and a plurality of massage rods which are disposed inside the outer surface layer; and a controller for controlling the whole operation of the mattress, the very low frequency wave heating massager for shoulder being detachably mounted on the top end of the mattress.
